(19) United States
(12) Patent Application Publication
(10) Pub. No.: US 2010/0142809 A1
(43) Pub. Date: Jun. 10, 2010

(54) METHOD FOR DETECTING MULTI MOVING OBJECTS IN HIGH RESOLUTION IMAGE SEQUENCES AND SYSTEM THEREOF

(75) Inventors: Jongho WON, Daejeon-city (KR); Eunjin KOH, Incheon (KR); Changseok BAE, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/615,590

(22) Filed: Nov. 10, 2009

(30) Foreign Application Priority Data
Dec. 8, 2008 (KR) 10-2008-0124121

(51) Int. Cl. G06K 9/00; G06T 1/60

(52) U.S. Cl. 382/165; 382/162; 345/530

(57) ABSTRACT

Provided is a method and apparatus for detecting multi moving objects in high resolution image sequences and performs moving objects on a screen using a general image collecting apparatus. The present invention provides a method of effectively removing the background of moving objects like motion of a leaf or reflection of a wave in an outdoor environment using a statistical method and uses a GPU installed in a general computer to process high resolution image sequences at high speed.

### RELATED APPLICATIONS

The present application claims priority to Korean Patent Application Serial Number 10-2008-0124121, filed on Dec. 8, 2008, the entirety of which is hereby incorporated by reference.

### BACKGROUND OF THE INVENTION

1. Field of the Invention

The present invention relates to a method for effectively detecting multi moving objects in an image, and more specifically, to a method for simultaneously detecting multi moving objects using high resolution image sequences collecting device and a graphics processing unit (GPU).

2. Description of the Related Art

A general method for detecting a moving object is used as an important step for tracking objects in various application fields such as a monitoring system, unmanned vehicle, object recognition, etc. The related art frequently exhibits incorrect detection due to a slow motion of a shadow, a motion of a leaf, light reflected from a wave in an outdoor environment, which only uses a simple difference image mechanism for the background. In addition, the object tracking using a method such as a motion detecting mechanism uses the difference between adjacent frames but cannot detect objects when the objects do not move for a while or slowly move.

Therefore, in order to overcome these disadvantages, a method such as Gaussian Mixture Model (GMM) of modeling a background by Gaussian mixing and learning model parameters in real time has been proposed. However, this method cannot also solve the incorrect detection problem that intermittently occurs due to the moving leaf and wave, etc. A method of using a fixed variance boundary value or assigning the equivalent weight to each channel under the assumption that all the channels have the same distribution is also limited in effectively detecting objects. In addition, since the method should process several Gaussian distributions for each pixel corresponding to the number of channels, it requires a significant amount of calculation. As a result, the method is not suitable to track the objects in the high resolution image sequences in real time.

### SUMMARY OF THE INVENTION

The present invention proposes to solve the above problems. It is an object of the present invention to provide a method for detecting objects capable of effectively removing a continuously moving background and rapidly processing high resolution image sequences by using a statistical method and a system thereof.

According to one aspect of the present invention, a method for processing image data is a method for processing image data based on a Gaussian Mixture Model (GMM). The method for processing image data based on a Gaussian Mixture Model (GMM) includes: collecting image data; performing initializing standard deviations, variance, mean, and weights of each model; converting an input image into a color space meeting predetermined purposes; and processing the image data based on the converted color space.

The processing the image data sets the weight for each image channel of the input image, which calculates a channel reflecting distance value (Dist).

The processing the image data may classify a pixel as a background or an object based on the calculated channel reflecting distance value.

In addition, the processing the image data may include arranging a plurality of models in sequence for small variance; comparing the channel reflecting distance value with a preset boundary value (S); classifying the pixel as a background or a moving object according to the comparison result.

The processing the image data may further include modifying the mean, variance, standard deviations, and weights of the model meeting the previously set conditions according to the comparison result.

The modifying can be performed in a range where the standard deviation of the model is above a preset value (D). The modified weight is subjected to normalization so that a sum of the weights of each model becomes 1.

The classifying may classify the pixel as a background if the sum of the weights of the model is larger than the preset value and classify the pixel as an object if the sum of the weights of the model is not larger than the preset value, when the channel reflecting distance value is smaller than the boundary value (S), calculate the channel reflecting distance value for the model of next sequence when the channel reflecting distance value is equal to or larger than the boundary value (S) and classify the pixel as an object when it is determined that the channel reflecting distance value is the final sequence of the calculated model.

The comparing may apply another boundary value (S) according to the pixel variation of each model. The boundary value (S) can apply a small value when the change in the pixel is small and apply a large value when the change in the pixel is large.

The method for processing image data may further include copying data including the standard deviation, variance mean, and weights to a memory of a general purpose GPU.

Moreover, the method for processing image data may further include copying the processed data from the memory of the general purpose GPU to a main memory.

The method for processing image data may further include post processing in order to remove the noise of the processed image data.

The post processing may be performed using a morphology mechanism.

There is provided a system for detecting an object according to one aspect of the present invention, including: a color space converter that converts a color space of an input image into a target color space to which weights for each channel are assigned; a data processor that processes data of the input image based on the weights; and a post processor that removes noise in the processed image to emphasize a moving object.

The post processor can use a morphology mechanism.

The data processor may include a general purpose GPU and can be configured to be connected to the outside of the data processor.

The method for detecting multi objects according to the present invention can effectively subtract only the moving objects from a continuously moving background such as leaf, wave, etc. such that it emphasizes the actual moving objects even in different adverse conditions to accurately track multi objects. In addition, the present invention can solve the speed reduction occurring when using the high resolution image sequences by using the GPU without adding a separate device, making it possible to rapidly perform more precise monitoring in a wider range even in a general computer.

### BRIEF DESCRIPTION OF THE DRAWINGS

FIG. 1 shows a system for detecting multi objects according to the present invention;

FIG. 2 shows a configuration a data processor used for a GPU to process high resolution image sequences at high speed according to one embodiment of the present invention;

FIG. 3 is a flowchart of a data processing process used for a method for detecting objects according to the present invention;

FIG. 4 is a flowchart showing in detail a data processing process according to the present invention; and

FIG. 5 is a diagram showing a process of modifying a matching model according to the present invention.

### DETAILED DESCRIPTION OF THE PREFERRED EMBODIMENTS

Detecting moving objects corresponds to a first step in a series of steps in order to implement image monitoring or object tracking. Therefore, the accuracy and efficiency of the object detection should be secured in order to implement the intelligent image processing or the intelligent image tracking. A method for detecting objects may include a background subtraction method using a difference between a background and an object, a frame difference method that compares two continuous image frames to find out the motion by the difference, and the like.

The background subtraction method is a widely used method in the object detection. When the background is complicated and the change is extreme, how accurately the background is learned in real time determines the accuracy of the object detection. A Gaussian Mixture Model (GMM), which is the most widely used method for modeling the background, uses a probabilistic learning method. The brightness distribution of each pixel of an image is approximate using the Gaussian Mixture Model and determines whether the measured pixel belongs to the background or the object in relation to the approximated model variable value.

Therefore, it is important in the method for detecting objects to effectively update the background in real time. For the channel configuring each image in the present invention, in order to reflect the statistical modeling and the characteristics of each channel using the statistical method, the method and system capable of accurately modeling the background and detecting the object by combining the data processing to which the weights for each channel are assigned are proposed. In the present invention, the channel means attributes such as color or brightness configuring images. The present invention can obtain more accurate results when emphasize the features of each color space, such as the change in color, the change in brightness, etc., by making the weights for each image channel different.

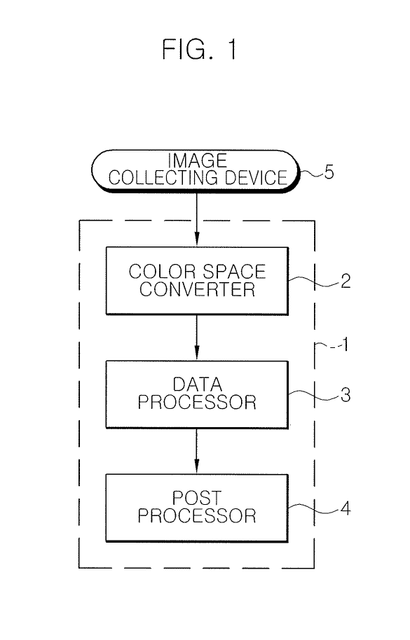

FIG. 1 shows a system for detecting multi objects according to the present invention. An apparatus 1 for detecting multi objects includes a color space converter 2 that converts a color space of an image received from an image collecting apparatus 5 into a color space to be easily processed, a data processor 3 that processes data from the input images, and a post processor 4 that effectively removes noise in the resultant images to emphasize the moving objects. The image collecting apparatus 5 that provides input images to the apparatus for detecting multi objects may be a separate apparatus from the system for detecting multi objects but can be integrated with the system for detecting multi objects.

The color space converter 2 converts the color space of the input image into the color space to be easily processed in order to improve the processing time by assigning the same weight under the assumption that each channel has the same distribution when generally using a Gaussian mode. The target color space to be converted is not specified as a specific color space but can use several color space in order to meet to each predetermined purpose. For example, a color space such as an HSV using a color of a pixel as one channel, a color space such as YUV using brightness as one channel, etc. can be used. In general, an Equation of transforming a RGB color space into a YUB color space is as follows.

$$[ \begin{matrix}Y \\ U \\ V\end{matrix} ] = [ \begin{matrix}Y \\ B - Y \\ R - Y\end{matrix} ] = [ \begin{matrix}0.299 & 0.587 & 0.114 \\ - 0.299 & - 0.587 & 0.886 \\ 0.701 & - 0.587 & - 0.114\end{matrix} ] [ \begin{matrix}R \\ G \\ B\end{matrix} ]$$

Y in YUV means brightness of each pixel and in the case of the system for tracking objects that is more sensitive to brightness, a higher weight is assigned to the Y channel in order to achieve the purpose. This method is not applied only to the high resolution image sequences but can be used for the general method for detecting objects.

The data processor 3 performs a role of subtracting moving objects from the background by effectively processing the data of the input images whose color space is converted by the color space converter 2. This process can be performed using the general purpose GPU mounted in a computer. First, in allocating memory space for storing information to be maintained at all times during the tracking of the objects, each pixel allocates the GMM by a number that multiplies the number of channels by the number of normal distribution to be maintained. Therefore, when C is a channel of an input image, W is an amplitude of an input image, H is a height of an input image, K is the number of Gaussian models to be maintained, and N is the number of additional information used in each model, the memory space is defined as a W*H*K*(C+N) number, wherein N means the standard deviations, variance, and weights of the model. However, this model can be configured of other shapes according to each application.

The post processor 4 performs a function of removing noise in the resultant image of the data processor, while further emphasizing the objects. In general, an image binarization process performed after the operation using the background subtraction causes a significant amount of noise, which affects the accuracy in detecting the object. In the related art, the calculation such as a Markov random field is used. However, this requires a large amount of calculation. As a result, when the density of pixel classified into other moving objects around the pixels classified into the moving objects is low, the method uses a simple morphology calculation method to remove it and when the density is high, the method classifies a hole classified as the surrounding background into the pixel of the moving object. The simplest method in consideration of the speed among the calculation methods uses a proper mixture of Erode calculation and Dilate calculation. The post processing method can be applied to a general application as it is, rather than the high resolution image sequences.

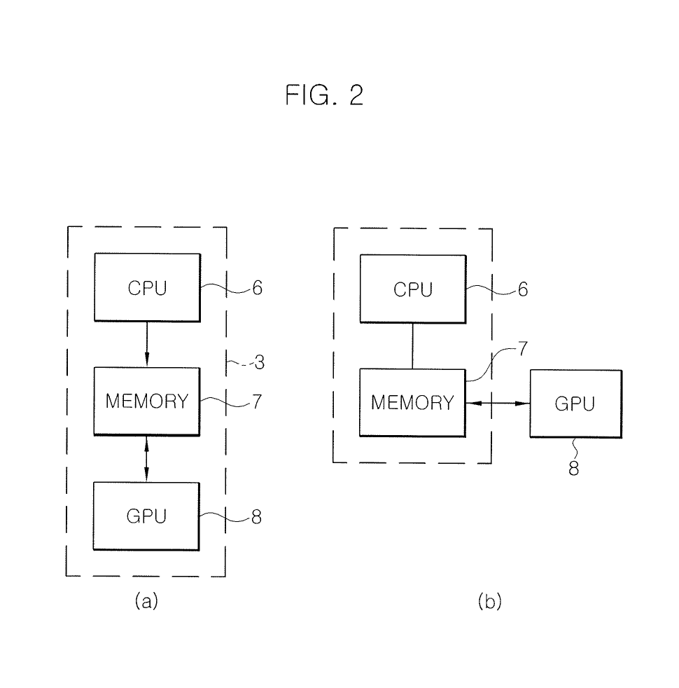

FIG. 2 shows in more detail the data processor according to the present invention. The data processor 3 includes a CPU 6, a memory 7, and a GPU 8, wherein the GPU 8 can be integrated with the data processor 3 as shown in FIG. 2(a), and can be positioned outside the data processor as shown in FIG. 2(b), as long as it can communicate with the data processor.

The operation of the CPU 6 will be described during the data processing. The CPU 6 first performs the initialization of the value to be continuously maintained (weight, mean, standard deviation, etc). Thereafter, the CPU 6 copies from a basic memory to the memory of the GPU 8 for each frame. The data are processed and the values are changed by using the copied memory values inside the GPU. The contents of the processed GPU memory are copied to a CPU. Thereby, the values such as the weight, mean, standard deviation, variance, etc. are continuously maintained.

The GPU 8 is a semiconductor chip that performs graphics calculation processing, which is referred to as a core. In general, the graphics card of the computer performs a role of processing image information, acceleration, signal conversion, screen output, etc. The performance of the graphics card varies according to a video RAM and a graphics chip. The performance of the graphics card chip set is generally referred to as GPU. The GPU is manufactured in order to achieve a graphic acceleration function so as to solve the bottle neck phenomenon occurring due to a graphic job. The graphic card is referred to as a graphics accelerator. In the present invention, when processing the high resolution image sequences at high speed, the graphics process can instead process the core functions, which are processed by the CPU 6, such that the cycle of the CPU can be used for other jobs and the load on the CPU can be reduced and more freely used.

The CPU 6 and GPU 8 may be the integrated processor. The CPU and GPU can be configured to be packaged together by several processes.

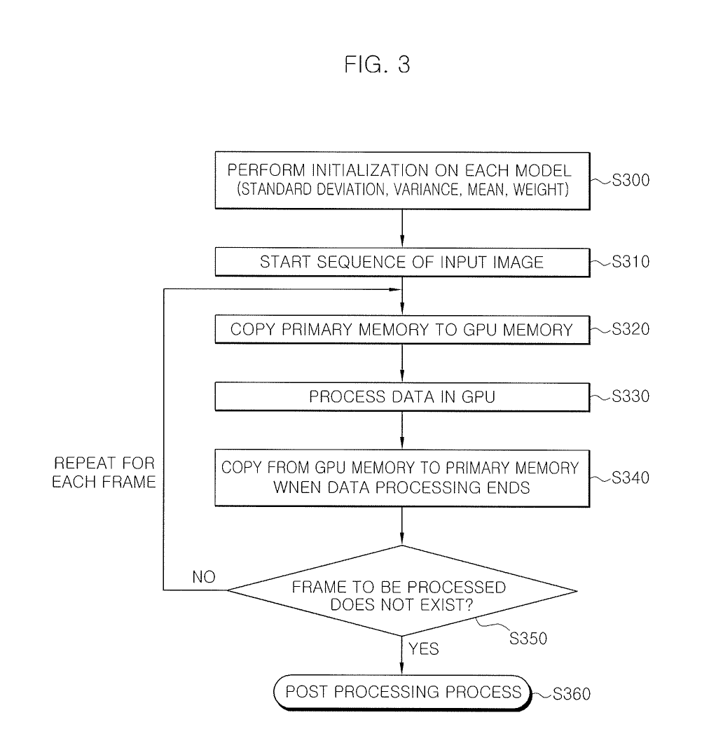

FIG. 3 schematically shows a data processing process of the data processor. The data processor first performs the initialization for the standard deviations, variance, mean, weights of each model (S300). When the weight is normalized, the sum of the weights of all the models is 1. When the initialization (S300) ends, the sequence of the input image starts (S310). At this time, the data to be continuously maintained for each frame are copied to the GPU memory 8in the memory 7 (S320). The GPU processes each data (S330). When the data processing ends, a process of copying the value to be continuously maintained in the GPU to the memory 7 is repeated. If there is no further frames to be processed, the post processing process is performed (S600).

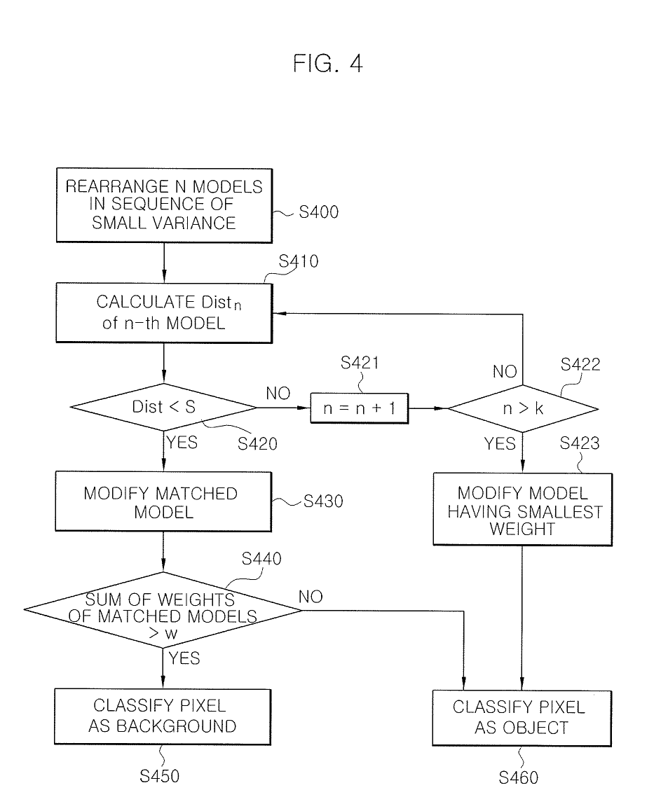

FIG. 4 shows a process of processing the data in the GPU. Each model is rearranged in sequence by small variance (S400). Herein, the small variance numerical value of the model means that the pixel values of each background are gathered around the mean value. When the variance is small, even though pixel value of the background and the object is slightly different, the object can be discriminated from the background. Thereafter, the distance value Dist of each model is calculated (S410).

When there is a correlation between the variables statistically, in which is considered by the distance measure, a Mahalanobis distance value is applied. The variance of variables is used to yield the Mahalanobis distance value. In other words, the Mahalanobis distance value is a value that standardizes the distance of each example from an mean of an independent variable. As the value is getting larger, the value is farther away from the distribution of the independent variable.

The present invention sets the weights for each channel and assigns them in order to obtain the distance value in order to determine the matching degree with the model. Thereby, the present invention makes the weights of each channel different to emphasize the features of each color space such as emphasizing the change in color or the change in brightness, thereby making it possible to obtain a more accurate result. The distance value to which the weights for each channel are assigned is referred to as the channel reflecting distance value (Dist).

The channel reflecting distance value Dist means a value that obtains the difference between an mean per channel of a model and a value per channel of a pixel of a currently input image in sequence by small variance, squares and sums the obtained value, and divides it by the variance. For example, if the input image is configured of three channels, m is an mean, v is a current pixel value, and var is the variance of a model, the equation is as follows.

Dist={w*(v₁−m₁)²+w₂*(v₂−m₂)²+w₃*(v₃−m₃)²}/var

At step S420, the channel reflecting distance value

Dist calculated for each model at step S410 and the preset boundary value (S) are compared. As the comparison result, if the channel reflecting distance value (Dist) is smaller than the boundary value (S), the current value v of the pixel matches the model and then, if the weight of the model is above a predetermined value at step S440, is classified as the background (S450). However, as the comparison result, if the channel reflecting distance value (Dist) is larger than the boundary value (S), the next variance calculates the channel reflecting distance value (Dist) for a large model (S421 and S410). The same equation is applied to the calculation of the channel reflecting distance value (Dist). The above process is repetitively performed on the plurality of models, such that if there is no matched model (S422), the current pixel is classified as the moving object (S460).

When the current pixel is classified as the moving object, the model is changed so that the mean of the model having the smallest weight in each model changes the model into the pixel value v, the variance and standard deviation is changed into a very large value, and the weight is changed into a very small value (S423).

However, if this classification is performed as it is and the model is not matched, the pixel whose mean is modified becomes the background since the mean of the model is similar to the input value of the pixel in the next frame. Therefore, only when the sum of the weighing values of the matched model is larger than the predetermined value (W), it is classified as the background (S440) and even when there is the matched model, if the weight is smaller than the boundary value, it is classified as the moving object (S460).

However, it is not preferable that the S value is applied to all the pixels at all times. By applying the same S value to all the pixels, the same standard deviation area for dividing the background and the object is applied. This means that a portion where the pixel is largely changed on the screen, for example, like the moving branches of a tree or a portion where the pixel is slightly changed like an inlet of no admittance area, etc. are processed in the same standard deviation area, such that it may be inappropriate to accurately detect the objects. Therefore, at a place where the change in the pixel is little rather than applying the same boundary value (S), the capability for detecting the moving object becomes high by applying the smaller S value accordingly and at a place where the change in the pixel is large, it is preferable to effectively remove the background by applying the larger S value.

Therefore, S is not a fixed value and a value, which is proportional to dev, can be used by several methods. In general, the following Equation is used but this can vary according to the purpose of the system.

S=d₀*dev²*S₀

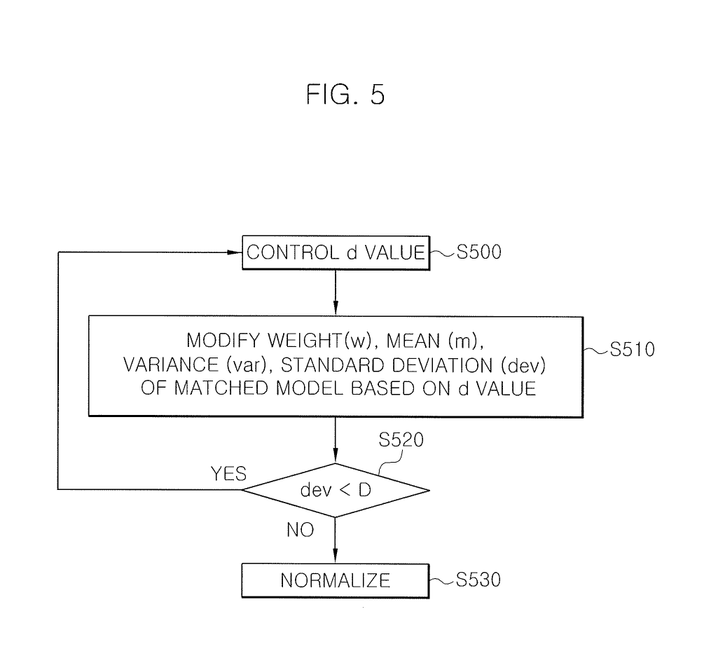

FIG. 5 shows an algorithm of modifying the matched model. The matched model is subjected to the model modifying process by quotient (d) (S510). In other words, each matched model for the current pixel value v modifies the weight, mean, variance, and standard deviation by the following Equation.

weight=d₁*weight+(1−d₁)

m=d₂*m+(1−d₂)*v (modification for each channel)

var=d₃*var+(1−d₃)*Dist

dev=√var

At this time, the method in the related art modifies the weight, mean, variance, and standard deviation for all the matched models. However, even though the image is not continuously changed, if the standard deviation is converged to a very small value, an incorrect detection is performed when a leaf extremely shakes due to hard blowing wind or the change in light reflected from a wave is severer.

Therefore, the present invention provides a step of comparing the standard deviation (dev) with the specific value (S520). As the comparison result, when it is smaller than the predetermined value, the value of quotient (d) is controlled (S500). The speed where the standard deviation converges to the small value is slow by controlling the quotient value (d). Consequently, when the values of each quotient (d) become 1, no modification for the values of the weight, mean, variance, and standard deviation can be performed. In this case, the standard deviations of each model stays at a predetermined level. The weights are modified and then, are necessarily subjected to the normalization so that the sum of the weights of each model becomes 1.

The method for detecting objects can be applied to the general application as it is when the object detection is not performed during the high resolution image sequences except for a fact that the method for detecting objects is driven in the GPU. In addition, since the foregoing color space converter, the data processor, and the post processor are only performed in sequence, but have a mutually independent relationship in an algorithm even though the algorithm of any one process can be changed, other algorithms are not necessarily changed. Therefore, each process can be independently used for other applications as it is.

What is claimed is:

1. A method for processing image data based on a Gaussian Mixture Model (GMM), comprising:
collecting image data;
performing initialization on the standard deviations, variance, mean, and weights of each model;
converting an input image into a desired color space; and
processing the image data based on the converted color space.

2. The method for processing image data according to claim 2, wherein the processing the image data sets the weight for each image channel of the input image to calculate a channel reflecting distance value (Dist).

3. The method for processing image data according to claim 3, wherein the processing the image data classifies a pixel as a background or an object based on the calculated channel reflecting distance value.

4. The method for processing image data according to claim 1, wherein the processing the image data includes:
arranging a plurality of models in sequence of small variance;
comparing the channel reflecting distance value with a preset boundary value (S); and
classifying the pixel as a background or a moving object according to the comparison result.

5. The method for processing image data according to claim 4, wherein the processing the image data further includes modifying the mean, variance, standard deviations, and weights of the model meeting the previously set conditions according to the comparison result.

6. The method for processing image data according to claim 5, wherein the modifying is performed in a range where the standard deviation of the model is above a preset value (D).

7. The method for processing image data according to claim 6, wherein the modified weight is subjected to normalization so that a sum of the weights of each model becomes 1.

8. The method for processing image data according to claim 4, wherein the classifying:
classifies the pixel as a background if the sum of the weights of the model is larger than the preset value and classifies the pixel as an object if the sum of the weights of the model is not larger than the preset value when the channel reflecting distance value is smaller than the boundary value (S),
calculates the channel reflecting distance value for the model of next sequence when the channel reflecting distance value is equal to or larger than the boundary value (S), and
classifies the pixel as an object when it is determined that the channel reflecting distance value is a final sequence of the calculated model.

9. The method for processing image data according to claim 4, wherein the comparing applies another boundary value (S) according to the pixel variation of each model.

10. The method for processing image data according to claim 9, wherein the boundary value (S) applies a small value when the change in the pixel is small and applies a large value when the change in the pixel is large.

11. The method for processing image data according to claim 1, further comprising copying data including the standard deviations, variance mean, and weights from a main memory to a memory of a general purpose GPU.

12. The method for processing image data according to claim 11, further comprising copying the processed data from the memory of the general purpose GPU to a main memory.

13. The method for processing image data according to claim 1, further comprising a post processing in order to remove the noise of the processed image data.

14. The method for processing image data according to claim 13, wherein the post processing is performed using a morphology mechanism.

15. A system for detecting an object, comprising:
a color space converter that converts a color space of an input image into a target color space to which weights for each channel are assigned;
a data processor that processes data of the input image based on the weights; and
a post processor that removes noise in the processed image to emphasize a moving object.

16. The method for processing image data according to claim 15, wherein the post processor uses a morphology mechanism.

17. The method for processing image data according to claim 15, wherein the data processor includes a general purpose GPU.

18. The method for processing image data according to claim 17, wherein the GPU is connected to the outside of the data processor.
